(19) United States
(12) Patent Application Publication
(10) Pub. No.: US 2026/0201577 A1
(43) Pub. Date: Jul. 16, 2026

(54) ELECTROLYSIS SYSTEM COMPRISING A PRESSURE ELECTROLYZER, AND METHOD FOR OPERATING AN ELECTROLYSIS SYSTEM OF THIS TYPE

(71) Applicant: Siemens Energy Global GmbH & Co. KG, München (DE)

(72) Inventors: Christian Reller, Minden (DE); Erik Wolf, Röttenbach (DE)

(21) Appl. No.: 19/137,310

(22) PCT Filed: Oct. 31, 2023
(86) PCT No.: PCT/EP2023/080331

§ 371 Date: Jun. 10, 2025

(30) Foreign Application Priority Data
Dec. 13, 2022 (DE) 10 2022 213 507.5

(51) Int. Cl. C25B 9/05; C25B 1/04; C25B 9/19; C25B 9/77; C25B 15/08

(52) U.S. Cl. CPC C25B 9/05; C25B 1/04; C25B 9/19; C25B 9/77; C25B 15/08

(57) ABSTRACT

The invention pertains to an electrolysis system with a high-pressure electrolyzer for producing hydrogen (H2) and oxygen (O2) at a nominal pressure (PN). The system includes multiple electrolysis cells, each with two half-cells separated by an ion-permeable membrane, forming an anode chamber and a cathode chamber. An oxygen product line connects to the anode chamber, while a hydrogen product line connects to the cathode chamber. The hydrogen and oxygen product lines lead to respective gas separators. The system features compressed gas accumulators for hydrogen and oxygen, enabling pressurized gas to be supplied to the electrolyzer on both sides, with adjustable primary pressures. The invention also includes a method for operating the system, where the electrolyzer is precharged with pressurized gas, and differential pressures are regulated to ensure efficient operation. This system supports both proton-exchange membrane (PEM) and alkaline electrolysis for high-pressure hydrogen and oxygen production.

### BACKGROUND

The invention relates to an electrolysis plant comprising a high-pressure electrolyzer for generating hydrogen and oxygen as product gases, having a multiplicity of electrolysis cells, each of which has two half-cells that are separated by an ion-exchange membrane so that an anode space and a cathode space are formed. The invention furthermore relates to a method for operating an electrolysis plant.

Hydrogen is currently generated for example by means of proton-exchange membrane (PEM) electrolysis or alkaline electrolysis. The electrolyzers produce hydrogen and oxygen from the supplied water with the aid of electrical energy.

An electrolyzer generally has a multiplicity of electrolysis cells, which are arranged next to one another. By means of water electrolysis, water is decomposed in the electrolysis cells into hydrogen and oxygen. In a PEM electrolyzer, distilled water is typically supplied as the reactant on the anode side and split into hydrogen and oxygen at a proton-exchange membrane (PEM). The water is oxidized to form oxygen at the anode. The protons pass through the proton-exchange membrane. Hydrogen is produced on the cathode side. The water is generally conveyed into the anode space and/or cathode space from a bottom side. A membrane is also provided in the case of alkaline electrolysis, this being formed as a semipermeable membrane or diaphragm that selectively allows transfer of particular ions. The electrolyte used is potassium hydroxide solution (KOH) with a concentration of typically 20-40%. Although the gastight membrane, the so-called diaphragm, allows transport of OH⁻ ions, at the same time it prevents mixing of the resulting product gases.

In plant technology, the electrolysis process takes place in the so-called electrolysis stack, which is composed of a plurality of electrolysis cells. In the electrolysis stack, which is at a DC voltage, water is introduced as the reactant, two fluid flows consisting of water and gas bubbles (oxygen O₂ and hydrogen H₂, respectively) emerging after passing through the electrolysis cells. Gas segregation is therefore subsequently necessary, i.e. phase segregation of water and the respective gaseous product gas in the phase mixture. It is usual in this case that a plurality of electrolysis cells, and furthermore a plurality of electrolysis units, are joined to one another by pipes and the respectively emerging gas/water mixture is supplied to a central gas segregator.

Despite the comparatively high gastightness of the ion-exchange membrane, for example of the ionomer of the proton-conducting membrane in the case of a PEM electrolysis, permeation of oxygen from the anode to the cathode, and of hydrogen from the cathode to the anode, takes place during operation. This is on the one hand attributable to the fact that complete gas impermeability of the ionomer cannot be achieved. On the other hand, the membrane itself absorbs water due to the direct contact with water. The contaminating gases that occur due to the permeation cause undesired side reactions, which can reduce the efficiency of the water electrolysis and sometimes damage the membrane.

In practice, therefore, there are small amounts of hydrogen in the oxygen gas flow and small amounts of oxygen in the hydrogen gas flow. The quantity of the respective contaminating gas depends on the electrolysis cell design and also varies under the influence of current density, catalyst composition and ageing, and moreover also depends on the membrane material of the electrolysis cell. It is an inherent feature of the system that the gas flow of the one product gas respectively contains the other product gas in very small amounts. In the further course of the process, in downstream steps of the gas purification, even small traces of oxygen are generally removed from the hydrogen with sometimes very elaborate and cost-intensive purification steps, especially when a particularly high product gas quality is required, as is the case for instance when using hydrogen, for example for fuel cells. Under certain circumstances, it may be necessary to reduce the contaminating gas concentration already immediately at or directly after the electrolysis cell, or the electrolysis stack, for example in gas segregators or gas separators connected downstream of the electrolyzer.

The problem is particularly relevant at high system pressures in electrolysis plants having high-pressure electrolyzers, and is exacerbated in their transient operating phases, for instance when starting or running up the unpressurized system of a high-pressure electrolyzer, in partial-load operation, or generally exacerbated in the event of load changes or aged membranes. This leads to restrictions of the way of operating or even prevention of further operation and a premature safety shutdown. Particularly in the event of positive load gradients, for instance when running up the electrolysis plant or when changing from partial-load operation to full-load operation, this creates critical states for the membrane because of differential pressures across the cell partition from the anode space to the cathode space and concomitant pressure gradients.

On the other hand, high-pressure electrolysis is of particular interest especially for large-scale industrial applications, and a development trend toward increased operating pressures is therefore clearly evident. For example, the water electrolyzer constitutes the main component in so-called power-to-gas plants. One of the most important operating parameters in this context is the operating pressure of the electrolyzer. The high-pressure operation is on the one hand rationalized by the requirements of the application to be served. On the other hand, a pressure increase is essential for efficient storage of the hydrogen because of its low density. This becomes clear when considering available PEM electrolyzers or alkaline electrolyzers as well as the demonstration projects carried out in recent years in the context of power-to-gas. A further advantage is the reduced ability of the gas to absorb water with an increasing pressure level, which leads to lower expenditure for gas drying. There are therefore extensive development activities to be seen in respect of electrolysis plants having high-pressure electrolyzers, as well as a demand to provide operating concepts for high-pressure electrolyzers on the industrial scale.

### SUMMARY

The object of the invention is therefore to provide an electrolysis plant having a high-pressure electrolyzer, which permits improved operation in respect of safety and plant efficiency.

The object is achieved according to the invention by an electrolysis plant comprising a high-pressure electrolyzer for generating hydrogen and oxygen as product gases at a rated pressure, having a multiplicity of electrolysis cells, each of which has two half-cells that are separated by an ion-exchange membrane so that an anode space and a cathode space are formed, wherein on the anode side an oxygen product line is connected to the anode space and on the cathode side a hydrogen product line is connected to the cathode space, wherein the hydrogen product line opens into a first gas separator and the oxygen product line opens into a second gas separator, wherein a first compressed-gas storage tank for hydrogen is connected on the cathode side and a second compressed-gas storage tank for oxygen is connected on the anode side to the high-pressure electrolyzer, so that pressurized gas can respectively be released from the compressed-gas storage tanks and supplied on the cathode side and on the anode side to the high-pressure electrolyzer, wherein a predetermined respective preliminary pressure can be adjusted on the cathode side and on the anode side.

The object is furthermore achieved according to the invention by a method for operating an electrolysis plant comprising a high-pressure electrolyzer, wherein in a start phase the high-pressure electrolyzer is precharged with pressurized gas to a preliminary pressure, hydrogen being released from a first compressed-gas storage tank and supplied on the cathode side to the high-pressure electrolyzer and oxygen being released from a second compressed-gas storage tank and supplied on the anode side to the high-pressure electrolyzer, a predetermined respective preliminary pressure being adjusted on the cathode side and on the anode side.

The advantages and preferred embodiments mentioned below in relation to the electrolysis plant may also be applied correspondingly to the method for operating an electrolysis plant.

The invention is based directly on the fact that in electrolysis plants having high-pressure electrolyzers for water electrolysis, the high-pressure electrolyzers are regularly depressurized after a particular time, or before prolonged down times, for instance for servicing or repair work. During the return to operation or restart of the depressurized electrolysis plant, the gas production of hydrogen and oxygen is therefore used for the pressure rise to the system pressure, or rated pressure. It has been found that this start phase may be highly dynamic in high-pressure electrolyzers. The partial load range is therefore run through as quickly as possible in the start phase, since it is subject to transient operating states with high contaminating gas concentrations because of gas permeation across the membrane. When beginning operation and running up the high-pressure electrolyzer, the contaminating gas concentrations may reach safety-critical values. In particular, the concentration of hydrogen as a contaminating gas in the anode space loaded with oxygen must crucially be evaluated and monitored because of the hydrogen permeation from the cathode space across the ion-conducting membrane into the anode space. The contaminating gas concentration decreases with an increasing load. The high-pressure electrolyzer is therefore run up with a very steep positive load gradient at a pressure rise of up to 10% of the rated pressure per second, and in this way the high-pressure electrolyzer in the electrolysis plant is put into operation and brought to the rated power. The maximum gas production is therefore reached in the electrolysis plant within about 10 s.

Further to this, in a high-pressure electrolyzer in the start phase, the time profile of the pressure rise lags far behind the gas volume flow increase. Very strong unsteady flow states are therefore set up inside the electrolysis cell as well as in the connected peripherals, for example the gas separators and the product lines. Because of the unsteady flow states, strong differential pressures and pressure gradients are imposed across the electrolysis cell, the corresponding half-cells and therefore the membrane. This becomes particularly significant in the first few seconds, during which the strongly increasing amount of gas has to accelerate a water column of the process water in front. The gas is thereby locally compressed temporarily until it finally breaks through the water column. This process is repeated periodically, and is the cause of intense pressure fluctuations across the electrolysis cell and the ion-selective membrane. This situation is also exacerbated by the fact that the gas volume flow on the cathode side, i.e. on the hydrogen side, is two times as great as on the anode side, i.e. on the oxygen side. The ion-selective membrane of the electrolysis cell, and in particular an ion-selective membrane that is already aged due to operation, may in this case suffer irreversible damage that would lead to failure of the electrolysis.

With progressive ageing, as well as because of defects in the ion-conducting membrane in individual cells, the latter may lose its property of withstanding differential pressures, which is necessary for operation. If this condition arises, the electrolysis must be expensively and time-consumingly overhauled, even if it would still be usable for steady-state operation. Previous technical safety concepts with simple differential-pressure limitation using respective pressure sensors are not capable of resolving highly dynamic processes during start-up. The plant system is hydraulically decoupled by the water columns between the electrolysis cells and the gas volumes in the gas separators. This is important particularly for future electrolysis plants having high-pressure electrolyzers with required rated pressures of at least 30 bar or significantly more.

In this context, the invention proposes to integrate a respective compressed-gas storage tank for hydrogen and oxygen into an electrolysis plant having a high-pressure electrolyzer. The oxygen compressed-gas storage tank is connected on the anode side, and the hydrogen compressed-gas storage tank is connected on the cathode side. Particularly in the start phase in which the high-pressure electrolyzer is being put into operation, the latter may be pressurized from these compressed-gas storage tanks with hydrogen on the cathode side and with oxygen on the anode side. A respective preliminary pressure may in this case be adjusted flexibly and according to requirements on the anode side and on the cathode side. In this way, the electrolysis plant is particularly advantageously configured so that the high-pressure electrolyzer is already prepared at a working pressure close to the rated pressure before the electrolysis per se, i.e. the energizing of the electrolysis cells with electrolysis current. This procedure of precharging with gas from the compressed-gas storage tanks reduces the stress on the membrane and avoids the highly dynamic effects associated with the steep load gradients and differential pressures across the membrane. The precharging may take place with a defined pressure ramp as a function of time to a predetermined preliminary pressure for hydrogen and oxygen. The compressed-gas storage tanks are correspondingly stocked with hydrogen and oxygen and kept under pressure. Storage tank pressures of up to 200 bar are possible while provisioning suitable storage volumes for beginning operation. The compressed-gas storage tanks are advantageously drivable in respect of storing and extracting compressed gas in the desired amount and at the desired pressure level.

This novel plant concept of the invention offers the possibility of dividing the operation of the electrolysis plant into a start phase with a precharging procedure and a subsequent load phase with the electrolysis operation per se and the energizing of the high-pressure electrolyzer. In the start phase, the anode space and the cathode space are brought for example to a preliminary pressure close to the operational rated pressure and prepared for the electrolysis operation per se at a rated pressure. This establishes operational readiness for the energizing and the electrolysis operation.

With the electrolysis plant of the invention, it is therefore for the first time possible and provided that the electrolysis plant is initially precharged with a defined preliminary pressure on the hydrogen side and/or on the oxygen side. That is to say, the corresponding pressurized gas—hydrogen or oxygen—is introduced from a compressed-gas storage tank into the high-pressure electrolyzer. Only then does the electrical loading begin. Because of the preliminary pressure, the gas volume flow now generated is only a fraction of that of the previous plant concepts, in which the product gases were generated at low pressure in the load phase. Moreover, the dynamic loadings of the membrane are effectively reduced, or minimized. The plant concept and the process management of a high-pressure electrolysis may be used and adapted substantially independently of the technology, i.e. for instance advantageously to different types of electrolyses, for instance alkaline water electrolysis or PEM water electrolysis.

In one embodiment of the electrolysis plant, the first compressed-gas storage tank is connected via a first extraction line and the second compressed-gas storage tank is connected via a second extraction line to the high-pressure electrolyzer. Division of the gas spaces and line systems for the hydrogen supply and the oxygen supply is thereby achieved at the desired preliminary pressure. Definition and optimization of a respective connection point of the first extraction line and of the second extraction line to the high-pressure electrolyzer is also locally possible and selectable under technical considerations, in order correspondingly to pressurize the anode space and the cathode space with the pressurized gas and precharge them to the preliminary pressure.

In one embodiment of the electrolysis plant, a drivable regulating fitting is connected into an extraction line so that a respective preliminary pressure can be adjusted on the cathode side and on the anode side. In the start phase, precise metering and monitoring of the external gas supply of the respective compressed gas—hydrogen or oxygen—from the corresponding external compressed-gas storage tank into the high-pressure electrolyzer is thereby achieved. Pressure differences across the ion-exchange membrane may thereby be reduced or avoided, or limited to a permissible value.

In the electrolysis plant, the first extraction line may be connected to the first gas separator and the second extraction line may be connected to the second gas separator. Connection to the respective gas separator on the anode side and on the cathode side is advantageous, the extraction lines then connecting to and opening into the gas space of the respective gas separator. A gas space in this case means the space, or the volume, above the liquid phase in the gas separators due to the phase segregation during operation of the high-pressure electrolyzer.

It is however also possible and preferred that, in the electrolysis plant, the first extraction line is connected to the cathode space and the second extraction line is connected to the anode space. Connection to the electrolysis stack having the stacks of electrolysis cells offers the possibility of direct and local pressurization of anodic and cathodic half-cells inside or in the vicinity of the electrolysis cell. The local pressure values of the respectively predetermined preliminary pressure across the ion-conducting membrane can therefore be adjusted and monitored even more accurately, particularly in the start phase during the precharging with the respective H₂ compressed gas or O₂ compressed gas in order to prepare for the electrolysis operation of the high-pressure electrolyzer. Combinations of the connections of the extraction lines to the gas separators and/or to the anode or cathode space are also possible.

In one embodiment of the electrolysis plant, a differential-pressure regulating device having a differential-pressure pickup is provided, the differential-pressure pickup being connected to a respective pickup point of the first extraction line and of the second extraction line, so that the differential pressure of the cathode-side preliminary pressure and of the anode-side preliminary pressure can be ascertained and regulated.

By this type of arrangement and coupling of the differential-pressure pickup, the differential pressure across the connected gas spaces or volumes may also be monitored indirectly or directly—depending on the connection topology selected—whether this is the differential pressure between the anode space and the cathode space or the differential pressure between the first gas separator and the second gas separator. The differential-pressure regulating device is in this case advantageously further usable not only in the start phase during the pressurization with compressed gas from the compressed-gas storage tanks, but also for the normal electrolysis operation that follows the start phase with energizing of the electrolysis cells and operation at a high rated pressure.

By this embodiment, very accurate “in situ” differential-pressure determination is at the same time directly possible even with high system pressures in the high-pressure electrolyzer. As an in situ state indicator, a direct differential-pressure measurement is implemented via further selected and representative measurement points in the electrolysis plant. The differential-pressure regulating device is provided for this purpose, which comprises the differential-pressure pickup which is configured in such a way that a differential pressure can be ascertained for example between the anode space and the cathode space, the value of which can be processed in the differential-pressure regulating device. The differential-pressure pickup, the differential-pressure measurement signal of which can be processed in the differential-pressure regulating device, is therefore connected via two selected pickup points—representative respectively of the anode space and of the cathode space. Advantageously, the differential-pressure pickup taps at the first extraction line and the second extraction line, this being a particularly simple implementation. The direct differential-pressure measurement allows very accurate and almost instantaneous state diagnostics and therefore reliable operational management of the electrolysis plant. In order to ascertain and evaluate the differential pressure, the differential-pressure regulating device may in addition have a differential-pressure pickup that can measure the differential pressure directly between the half-cells. This measurement may take place at different pickup points according to requirements.

In exemplary embodiments, the differential-pressure regulating device is designed for differential-pressure limitation, a maximum value of the differential pressure being adjusted.

A particularly simple and at the same time functional differential-pressure limitation between the anode space and the cathode space is thereby achieved, and therefore the differential pressurization across the membrane is limited according to an adjusted maximum value of the differential pressure, the gas transfer being monitored at the same time. In general, the lowest possible differential pressure is preferable during operation.

In exemplary embodiments, safe operation of the electrolysis plant is possible as a result of the differential-pressure limitation since an instantaneous differential pressure can reliably be monitored and regulated in relation to a permissible maximum differential pressure. The maximum permissible differential pressure may also be predetermined and adjusted, or adapted, in the differential-pressure regulating device.

In exemplary embodiments, in the electrolysis plant, a pressure sensor is arranged at the first gas separator and at the second gas separator.

A respective pressure measuring device having a pressure sensor for determining an absolute pressure value is thereby in addition connected to the gas separators, so that an absolute pressure in the gas phase of the first gas separator and an absolute pressure in the gas phase of the second gas separator can also be determined in addition to the differential pressure. Via the differential-pressure pickup, the differential pressure between the gas separators can moreover be determined directly and accurately. The measurement signals for the differential pressure and the absolute pressure values ascertained in the gas separators may be processed in the differential-pressure regulating device. With the absolute pressure measurement, the preliminary pressure in the start phase and the system pressure in steady-state operation, i.e. the rated pressure, may be ascertained by an absolute pressure measurement in the first gas separator and in the second gas separator. The values may advantageously likewise be read into the differential-pressure regulating device and processed there, or this functionality is integrated in a superordinate control unit of the electrolysis plant, which then comprises the one differential-pressure regulating device.

In one embodiment of the electrolysis plant, a first reactant line is connected on the cathode side to the cathode space and a second reactant line is connected on the anode side to the anode space.

In this way, for example in an embodiment of the electrolysis plant having a PEM high-pressure electrolyzer, two reactant circuits may be produced. Water therefore circulates not only through the anode space but also through the cathode space. It is, however, also possible for the PEM high-pressure electrolyzer to be produced only with a circuit on the anode side. Water, in particular deionized water, which may be supplied via the two reactant lines on the anode side and on the cathode side, is in this case envisaged as a reactant for carrying out a PEM electrolysis.

In exemplary embodiments, in the electrolysis plant, the ion-exchange membrane is configured as a proton-exchange membrane, so that a PEM electrolysis can be carried out.

In one embodiment of the electrolysis plant, the ion-exchange membrane in the high-pressure electrolyzer is configured as a diaphragm which selectively allows transfer of hydroxide ions, so that an alkaline electrolysis can be carried out. In an embodiment for alkaline electrolysis, an electrolyte, for example potassium hydroxide solution with a concentration of 20%-40%, may then be supplied as a reactant via the reactant lines to the electrolysis cell. In principle, combinations of high-pressure electrolyzers with different technology, which are based on alkaline electrolysis or PEM electrolysis, may also be installed in the electrolysis plant.

The invention may therefore advantageously be applied to different types of high-pressure electrolyzers in an electrolysis plant, for instance alkaline water electrolysis as well as PEM electrolysis, safe operational starting and adjustment of a preliminary pressure in the start phase being achieved by the compressed-gas storage tanks and the differential-pressure regulating device with differential-pressure pickups. In particular, the risk of undesired gas transfer from one side of the electrolysis half-cell to the other side by hydrodynamic effects and impermissibly high differential pressures is thereby minimized and monitored.

In exemplary embodiments, in the electrolysis plant, the ion-exchange membrane is configured as a proton-exchange membrane, so that a PEM electrolysis can be carried out. In the case of a PEM electrolysis, the proton-exchange membrane may be embodied on the basis of a gastight and liquid-tight fluoropolymer.

In an acidic or proton-exchange membrane electrolyzer (PEM electrolyzer) distilled or deionized water is split into hydrogen and oxygen by electric current. It consists of a proton-exchange polymer membrane (“proton-exchange membrane” or “polymer-electrolyte membrane”, abbreviated to “PEM”). This is coated on the cathode side with a porous electrode consisting of carbon-supported platinum and on the anode side with noble metals (usually iridium and ruthenium) in metallic or oxide form. An external voltage is applied to these electrodes. Water is usually supplied as a reactant on the anode side of the electrolyzer. Both half-cells or alternatively only the cathode side may also be supplied with water, this depending on the intended use. The catalytic effect of the noble-metal electrode leads to decomposition of the water on the anode side: this produces oxygen, free electrons and positively charged H⁺ ions. The hydrogen ions diffuse through the proton-conducting membrane onto the cathode side, where they combine with the electrons to form hydrogen as a product gas.

In a further embodiment of the electrolysis plant, the ion-exchange membrane is configured as a diaphragm which selectively allows transfer of hydroxide ions, so that an alkaline electrolysis can be carried out.

In an alkaline electrolyzer, with a DC voltage of at least 1.5 volts, hydrogen is formed at the cathode and oxygen is formed at the anode. The electrolyte used is potassium hydroxide solution (KOH) with a concentration of typically 20%-40%. A gastight membrane, the so-called diaphragm, is used as the ion-exchange membrane. Although it allows transport of OH⁻ ions, at the same time it prevents mixing of the resulting product gases. The electrodes used are so-called “DSA electrodes” (Dimensionally Stable Anodes), usually titanium electrodes with a ruthenium oxide coating. They consist of expanded metals which are coated with a noble metal catalyst oxide, for example ruthenium oxide or iridium oxide. There are, however, also systems comprising Raney nickel catalysts in a gas diffusion electrode. Alkaline electrolyzers are employed on a large scale worldwide.

In a method for operating such an electrolysis plant having a high-pressure electrolyzer, therefore, in a start phase the high-pressure electrolyzer is precharged with pressurized gas to a preliminary pressure, hydrogen being released from a first compressed-gas storage tank and supplied on the cathode side to the high-pressure electrolyzer, a cathode-side preliminary pressure being adjusted. At the same time, oxygen is released from a second compressed-gas storage tank and supplied on the anode side to the high-pressure electrolyzer, a predetermined preliminary pressure being adjusted on the anode side. In this way, the high-pressure electrolyzer in the electrolysis plant is initially precharged to the preliminary pressure in the start phase for the high-pressure operation. The electrolysis is preferentially not yet begun in this start phase, i.e. an electrolysis current does not yet flow in the start phase.

In exemplary embodiments, in the method, a differential pressure Δp between the anode-side preliminary pressure p₂ and the cathode-side preliminary pressure p₁ is measured, the measurement signal being read into the differential-pressure regulating device and compared with a reference value.

The reference value may be a safety-relevant maximum permissible differential-pressure value or a setpoint value for a predetermined differential pressure. It is also possible that a plurality of reference values which are adapted to different operating procedures, in particular when starting up, are stored in the differential-pressure regulating device. The measurement signal for the differential pressure is processed in the differential-pressure regulating device, and if required—depending on the stored control algorithm—a regulating intervention is performed. This may, for example, be the case in order to ensure the intended pressure increase for the start phase with a pressure ramp of the preliminary pressures as a function of time, respectively on the anode side and on the cathode side.

In the method, hydrogen is supplied from the first compressed-gas storage tank to the first gas separator and oxygen is supplied from the second compressed-gas storage tank to the second gas separator. Pressurization of the gas spaces of the gas separators in order to increase the system pressure in the start phase is particularly straightforwardly possible.

Pressurization of the electrolyte stack in the half-cells of the anode space and of the cathode space is in principle likewise possible, as an alternative or additional measure to the gas supply into the gas separators.

In one embodiment of the method, the cathode-side preliminary pressure of the hydrogen is adjusted to be equal to the anode-side preliminary pressure of the oxygen.

This operating procedure for the pressurization in the start phase, and optionally during normal operation, would correspond to a pressure difference of zero or of almost zero across the ion-selective membrane. This provides an operating procedure that places particularly little stress on the materials.

It is also possible that the cathode-side preliminary pressure of the hydrogen is adjusted to be greater than the anode-side preliminary pressure of the oxygen.

In this case, for example, pressure differences of the preliminary pressures of from a few tens of mbar to about 500 mbar may be advantageous, depending on the specific plant design and the hydrostatic conditions in the vessel construction and the layout of the corresponding systems and components that convey water.

In the method, the electrolysis current is turned on only after the respective preliminary pressure is reached in the high-pressure electrolyzer, hydrogen and oxygen being generated as product gases and a high-pressure electrolysis being carried out at a rated pressure.

The electrolysis current is therefore advantageously turned on only after the start phase and the pressurization to the predetermined anode-side and cathode-side preliminary pressure. The rated pressure during the high-pressure electrolysis then carried out is typically more than 30 bar, and may be up to 100 bar or more. Rated pressures of from 35 bar to 80 bar are typically preferred.

In exemplary embodiments, the high-pressure electrolysis is carried out preferably with a rated pressure of at least 30 bar.

The preliminary pressure that is respectively adjusted on the anode side and on the cathode side may be between 1% and 99% of the rated pressure. For reasons of energy and for a stable operating changeover to the electrolysis after the start phase, the preliminary pressure may already almost correspond to the rated pressure, or be only slightly less than the rated pressure; for example, the pressurization may be adjusted to between 90% and 99% of the rated pressure.

### BRIEF DESCRIPTION OF THE FIGURE

Exemplary embodiments of the invention are explained in more detail with the aid of a drawing in which, schematically and in a highly simplified fashion, the

FIG. 1 shows an electrolysis plant having a high-pressure electrolyzer according to the invention.

### DETAILED DESCRIPTION

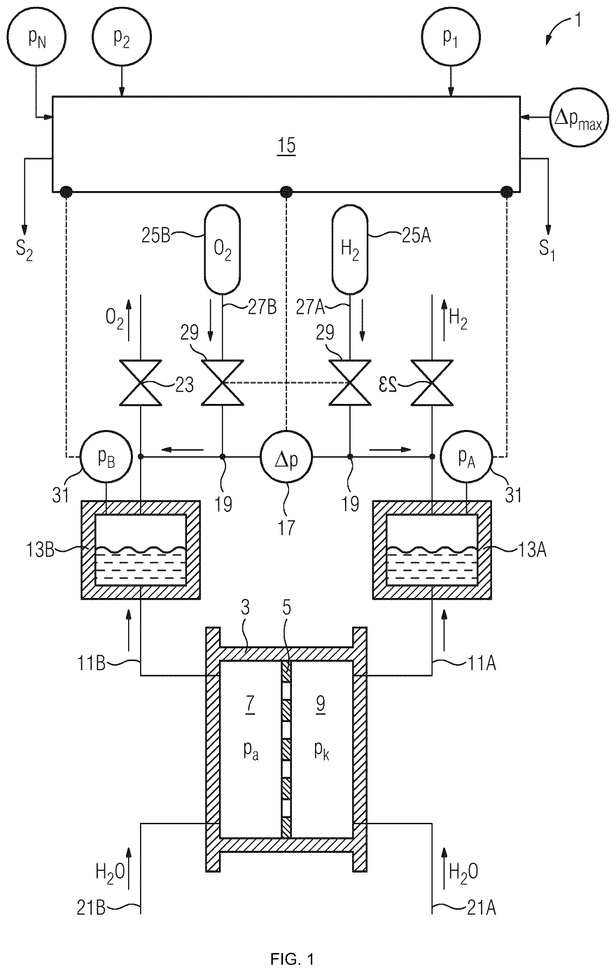

FIG. 1 represents an electrolysis plant 1 in a highly simplified detail of plant parts and components. The electrolysis plant 1 has a high-pressure electrolyzer 3, which is optionally embodied as a PEM electrolyzer or as an alkaline electrolyzer and is designed for a high rated pressure pr of at least 25 bar as the working pressure.

The electrolyzer 3 comprises a cathode space 9 and an anode space 7, which are separated by an ion-exchange membrane 5. The anode space 7 and the cathode space 9 are respectively composed of, and formed by, a multiplicity of respective anodic or cathodic half-cells (not represented in detail in the FIG) which are stacked in an axial direction. The cathodic half-cells and the anodic half-cells are combined to form a respective electrolysis cell, and are each separated by an ion-conducting membrane 5. The FIG. therefore shows a vertically aligned high-pressure electrolyzer 3, which is designed for the electrochemical splitting of water H₂O or an electrolyte as the reactant into hydrogen H₂ and oxygen O₂ as product gases by means of electric current. In the case of an acidic electrolysis, deionized water H₂O is used as the reactant. In the case of an alkaline electrolysis, a lye is employed, for example potassium hydroxide KOH in an aqueous solution with a concentration of typically from 20% to 40%. A plurality of such electrolysis cells may be connected in series in horizontally stacked, so-called electrolysis stacks.

In the exemplary embodiment shown in FIG. 1, the high-pressure electrolyzer 3 in the electrolysis plant 1 is embodied as a PEM electrolyzer for high rated pressures p_{N}. Each electrolysis cell has a proton-exchange membrane 5 based on a fluoropolymer, applied to which on both sides there is a respective electrode—an anode and a cathode—via which an external DC voltage is applied during operation. A first reactant line 21A for supplying water H₂O to the cathode space 9 is provided on the cathode side. A second reactant line 21B for supplying water H₂O to the anode space 7 is connected on the anode side. This creates two water circuits in the high-pressure electrolyzer 3 configured as a PEM electrolyzer. Water H₂O therefore circulates not only through the anode space 7 but also through the cathode space 9. It is, however, also possible for the high-pressure electrolyzer 3 to be produced only with a circuit on the anode side.

During operation of the electrolysis plant 1, the oxygen O₂ generated is taken from the anode space 7 in the electrolysis cell via an oxygen product line 11B. On the cathode side, a hydrogen product line 11A is provided for taking the hydrogen H₂ generated from a cathode space 9.

For the respective phase segregation of the phase mixture consisting of the respective product gas and water, a first gas separator 13A is connected downstream to the hydrogen product line 11A. Correspondingly, a second gas separator 13B is connected downstream to the oxygen product line 11B. During operation, phase segregation may therefore be achieved in such a way that there is a gas space containing the gas phase in the upper region of the gas separators 13A, 13B while the liquid phase is present at the bottom of the gas separators 113A, 13B, i.e. at a certain water level or filling level. The product gases hydrogen H₂ and oxygen O₂ that are phase-segregated from the water in this way are discharged via a hydrogen product line 11A or oxygen product line 11B leading off from the corresponding gas separator 13A, 13B and further processed in downstream processes. For example, the hydrogen H₂ is purified in a gas purification process and compressed for further purposes. In order to regulate the extraction of the product gases hydrogen H₂ and oxygen O₂, a valve 23 is respectively built into the product lines 11A, 11B leading off.

A first separate compressed-gas storage tank 25A filled during operation with hydrogen H₂ at high pressure is joined on the cathode side via a first extraction line 27A to the first gas separator 13A. Correspondingly, a second separate compressed-gas storage tank 25B filled during operation with oxygen at high pressure is provided, which is joined on the cathode side via a second extraction line 27B to the second gas separator 13B. A drivable control fitting 29 is respectively connected into the extraction lines 27A, 27B so that the flow rate (volume or mass flow) and the pressure level can be adjusted during extraction of gas from the compressed-gas storage tanks 25A, 25B.

The electrolysis plant 1 has a differential-pressure regulating device 15, which comprises a differential-pressure pickup 17. A differential-pressure pickup 17 that taps at a respective pickup point 19 on the first extraction line 27A and on the second extraction line 27B is thus connected across the gas spaces. In addition, a respective pressure measuring device 31 for determining an absolute pressure value is connected to the gas separators 13A, 13B so that, besides the differential pressure Δp relating to the gases in the extraction lines 27A, 27B, an absolute pressure p_{A} in the gas phase of the first gas separator 13A and an absolute pressure p_{B} in the gas phase of the second gas separator 13B can also be determined. Indirectly, determination of the differential pressure between the anode space 7 and in the cathode space 9 may also be carried out. In addition to this, a further differential-pressure pickup 17—not shown in the FIG. 1—may also be built in, which taps across the anode space 7 and the cathode space 9 so that a value of the differential pressure Δp between the cathode space 9 and the anode space 7 can also be determined directly.

The measurement signals for the differential pressure and the pressure values p_{A} and p_{B} in the gas separators 13A, 13B are processed in the differential-pressure regulating device 15. As an input quantity for the differential-pressure regulating device, a maximum differential pressure Apₘₐₓ is stored, can be read in or is adjustable. This value of the maximum differential pressure Apₘₐₓ may be adapted if required to the respective selected or typical operating conditions of the high-pressure electrolyzer 3 and the state of ageing of the ion-exchange membrane 5. Besides the nominal pressure pr of the high-pressure electrolyzer 3, further adjustable setpoint values are also the predetermined preliminary pressure p₁ for the hydrogen H₂ from the compressed-gas storage tank 25A as well as the preliminary pressure p₂ for the oxygen O₂ from the compressed-gas storage tank 25B. The differential-pressure regulating device 15 is configured for the output of control signals S₁, S₂, which may be transmitted to a superordinate control system (not represented in detail) of the electrolysis plant 1. The physical operating parameters of the electrolysis plant 1, for instance the electrolysis current, the electrolysis current density, the reactant volume flows, the system pressure or the differential pressure Δp<Δpₘₐₓ, as well as the respective volume flows via the extraction lines 27A 27B, may therefore be adjusted and adapted. The latter takes place by a regulating intervention on the regulating fitting 29.

This produces a plant concept with which, when beginning the operation of the electrolysis plant 1 in the start phase, the high-pressure electrolyzer 3 may initially be supplied on the cathode side with hydrogen H₂ at the preliminary pressure p₁ and on the cathode side with oxygen O₂ at a preliminary pressure p₂. The high-pressure electrolyzer 3 is therefore initially precharged to a preliminary pressure in the start phase, a predetermined respective preliminary pressure p₁, p₂ being adjusted on the cathode side and on the anode side. Electrolysis does not yet take place in this start phase, i.e. the electrolysis cells are not energized with electrolysis current, so that product gases are not yet formed. An operating mode in which the preliminary pressure p₁ on the cathode side is selected and adjusted to be greater than the preliminary pressure p₂ on the anode side may be preferred, depending on the design of the electrolysis cells and the materials. The adjusted preliminary pressures p₁, p₂ are selected to be lower than the operational rated pressure pr of the high-pressure electrolyzer 3 during the electrolysis. The values of the preliminary pressures p₁, p₂may be adapted flexibly to the respective requirements and adjusted in the range of between 1% and 99%. For reasons of energy and hydrodynamic reasons, it is preferable to adjust relatively high preliminary pressures p₁, p₂ close to the rated pressure p_{N} of the high-pressure electrolyzer 3, i.e. to precharge at more than 90% of the rated pressure p_{N}. Then, when the electrolysis cells are energized after the start phase and the pressure rise, the gas volume flow of the hydrogen H₂ and oxygen O₂ generated is significantly less, because of the high pressure level already set up, than without the precharging by the compressed gases introduced into the high-pressure electrolyzer 3. In the normal operating mode after the start phase, rated pressures pr of from more than 30 bar up to 200 bar, typically between 35 bar and 80 bar, are possible in the high-pressure electrolyzer 3. By the pressure sensors 31, particularly in the start phase, the gas-phase pressure in the gas separators 13A, 13B may be measured and processed. A setpoint/actual comparison of the measurement value with the predetermined preliminary pressure p₁ on the cathode side and the preliminary pressure p₂ on the anode side is performed. In this way, when beginning operation of the electrolysis plant 1, the pressure ramp adjusted during the pressurization of the high-pressure electrolyzer 3 with hydrogen H₂ and oxygen O₂ from the compressed-gas storage tanks 25A, 25B may be regulated particularly in the start phase. In the start phase, moreover, the absolute pressure values p_{A}, p_{B} in the gas phases of the first gas separator 13A and of the second gas separator 13B may be ascertained by a respectively introduced pressure measuring device 31 and compared the preliminary pressures p₁, p₂ according to the selected pressure ramp. In the high-pressure electrolysis operation that follows the start phase, this embodiment serves in addition for safety-related monitoring and regulation, and if appropriate correction and adaptation, of the pressure states across the ion-selective membrane 5.

The differential-pressure regulating device 15 may also be designed as a constituent part of, and integrated into, the superordinate control system, or control-technology system—not represented in detail—of the electrolysis plant 1. The control system is therefore designed for controlling the operation of the electrolysis stack in the high-pressure electrolyzer 3. With the aid of the control system, for example, a predeterminable absolute pressure pₐ may be adjusted as a setpoint value in the anode space 7 and a predeterminable absolute pressure pₖ may be adjusted as a setpoint value in the cathode space 9; for example, operation in which the anode-side pressure pa is adjusted to be greater than the pressure pₖ in the cathode space 9 is also possible if required. Corresponding pressure sensors are then connected to, or introduced into, the anode space 7 and the cathode space 9 in order to ascertain the absolute pressure pk in the cathode space 9 and the pressure pₐ in the anode space 7. In this way, the possible negative consequences of membrane damage during operation of a high-pressure electrolyzer 3 are minimized, since less hydrogen migrates through the membrane from the cathode space 9 into the anode space 7 in the event that the ion-exchange membrane 5 is breached. An emergency running feature in the high-pressure electrolysis until plannable inspection and maintenance is thereby achieved.

After the precharging of the high-pressure electrolyzer 3 with the desired preliminary pressure p₁, p₂ in the start phase, the electrolysis operation is started. During operation of the electrolysis plant 1, reactant water H₂O is supplied via the reactant lines 21A, 21B to the high-pressure electrolyzer 3 and hydrogen H₂ and oxygen O₂ are generated as product gases. With the differential-pressure pickup 17, a differential pressure Δp between the first gas separator 13A and the second gas separator 13B across the extraction points 19 to the extraction lines 27A, 27B may now also be measured during electrolysis operation. The measurement signal is read into the differential-pressure regulating device 15 and compared with the reference value Δpₘₐₓ. When the differential pressure Δp is less than a maximum permissible reference value Δpₘₐₓ, the high-pressure electrolysis operation is continued.

In the event of a differential pressure Δp that is greater than the reference value Δpₘₐₓ, a shutdown operating mode is initiated by the differential-pressure regulating device 15. This may also take place in the superordinate control unit, or control-technology unit, by corresponding control signals S₁, S₂ being sent from the differential-pressure regulating device 15 to a superordinate control unit.

Particularly because of the more precise differential-pressure measurement, high-pressure electrolyzers 3 having a high system pressure of at least 30 bar may also reliably and precisely be started up and brought into the electrolysis operation at the rated pressure p_{N}. When restarting, or starting up the unpressurized system, the electrolysis is not turned on and used for the gas production and the pressure rise to the rated pressure P_{N}, but instead the high-pressure electrolyzer 3 is kept unenergized in respect of the electrolysis and is initially precharged to a preliminary pressure p₁, p₂.

1. An electrolysis plant comprising:
a high-pressure electrolyzer for generating hydrogen (H₂) and oxygen (O₂) as product gases at a rated pressure (P_{N}), having a multiplicity of electrolysis cells, each of which has two half-cells that are separated by an ion-exchange membrane so that an anode space and a cathode space are formed,
wherein on an anode side an oxygen product line is connected to the anode space and on a cathode side a hydrogen product line is connected to the cathode space
wherein the hydrogen product line opens into a first gas separator and the oxygen product line opens into a second gas separator,
wherein a first compressed-gas storage tank for hydrogen (H₂) is connected on the cathode side and a second compressed-gas storage tank for oxygen (O₂) is connected on the anode side to the high-pressure electrolyzer so that pressurized gas can respectively be released from the compressed-gas storage tanks and supplied on the cathode side and on the anode side to the high-pressure electrolyzer wherein a predetermined respective preliminary pressure can be adjusted on the cathode side and on the anode side.

2. The electrolysis plant as claimed in claim 1, wherein the first compressed-gas storage tank is connected via a first extraction line and the second compressed-gas storage tank is connected via a second extraction line to the high-pressure electrolyzer.

3. The electrolysis plant as claimed in claim 2, wherein a drivable regulating fitting is connected into an extraction line so that a respective preliminary pressure (p₁, p₂) can be adjusted on the cathode side and on the anode side.

4. The electrolysis plant as claimed in claim 2, wherein the first extraction line is connected to the first gas separator and the second extraction line is connected to the second gas separator.

5. The electrolysis plant as claimed in claim 4, wherein the first extraction line is connected to the cathode space and the second extraction line is connected to the anode space

6. The electrolysis plant as claimed in claim 2, comprising a differential-pressure regulating device having a differential-pressure pickup, which is connected to a respective pickup point of the first extraction line and of the second extraction line, so that the differential pressure (Δp) of a cathode-side preliminary pressure (p₁) and of the-a anode-side preliminary pressure (p₂) can be ascertained and regulated.

7. The electrolysis plant as claimed in claim 6, wherein the differential-pressure regulating device is designed for differential-pressure limitation, a maximum value of the differential pressure (Δpₘₐₓ) being adjusted.

8. The electrolysis plant as claimed in claim 1, wherein a pressure sensor is arranged at the first gas separator and at the second gas separator.

9. The electrolysis plant as claimed in claim 1, wherein a first reactant line is connected on the cathode side to the cathode space and a second reactant line is connected on the anode side to the anode space.

10. The electrolysis plant as claimed in claim 1, claims, wherein the ion-exchange membrane is configured as a proton-exchange membrane, so that a PEM electrolysis can be carried out.

11. The electrolysis plant as claimed in claim 1, wherein the ion-exchange membrane is configured as a diaphragm which selectively allows transfer of hydroxide ions, so that an alkaline electrolysis can be carried out.

12. A method for operating an electrolysis plant comprising a high-pressure electrolyzer as claimed in claim 1, wherein in a start phase the high-pressure electrolyzer is precharged with pressurized gas to a preliminary pressure, hydrogen (H₂) being released from a first compressed-gas storage tank and supplied on the cathode side to the high-pressure electrolyzer and oxygen (O₂) being released from a second compressed-gas storage tank and supplied on the anode side to the high-pressure electrolyzer, a predetermined respective preliminary pressure (p₁, p₂) being adjusted on the cathode side and on the anode side.

13. The method as claimed in claim 12, wherein a differential pressure (Δp) between a anode-side preliminary pressure (p₂) and a cathode-side preliminary pressure (p₁) is measured, the measurement signal being read into a differential-pressure regulating device and compared with a reference value (Δpₘₐₓ).

14. The method as claimed in claim 12, wherein hydrogen (H₂) is supplied from the first compressed-gas storage tank to the first gas separator and oxygen (O₂) is supplied from the second compressed-gas storage tank to the second gas separator.

15. The method as claimed in claim 12, wherein a cathode-side preliminary pressure (p₁) of the hydrogen (H₂) is adjusted to be equal to a anode-side preliminary pressure (p₂) of the oxygen (O₂).

16. The method as claimed in claim 12, wherein a cathode-side preliminary pressure (p₁) of the hydrogen (H₂) is adjusted to be greater than a anode-side preliminary pressure (p₂) of the oxygen (O₂).

17. The method as claimed in claim 12, wherein the electrolysis current is turned on after the respective preliminary pressure (p₁, p₂) is reached in the high-pressure electrolyzer hydrogen (H₂) and oxygen (O₂) being generated as product gases and a high-pressure electrolysis being carried out at a rated pressure (P_{N}).

18. The method as claimed in claim 17, wherein a high-pressure electrolysis is carried out with a rated pressure (p_{N}) of at least 30 bar.
